(19) United States
(12) Patent Application Publication
(10) Pub. No.: US 2010/0036784 A1
(43) Pub. Date: Feb. 11, 2010

(54) SYSTEMS AND METHODS FOR FINDING HIGH QUALITY CONTENT IN SOCIAL MEDIA

(75) Inventors: Gilad Mishne, Santa Clara, CA (US); Benoit Dumoulin, Palo Alto, CA (US); Aristides Gionis, Barcelona (ES); Debora Donato, Barcelona (ES); Yevgeny Agichtein, Atlanta, GA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/187,580

(22) Filed: Aug. 7, 2008

(51) Int. Cl. G06N 5/00

(52) U.S. Cl. 706/45

(57) ABSTRACT

The present invention is directed towards systems and methods for identifying high quality content in a social media environment. The method according to one embodiment of the present invention comprises retrieving a content item and retrieving a plurality of quality features associated with said content item wherein said quality features comprise intrinsic, usage and relationship features. The method then performs an analysis of said content item against said quality features and generates a quality score based on said analysis.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to locating high quality items in a social media context. More specifically, embodiments of the present invention are directed towards systems and methods for exploiting the nature of social media to identify high quality media on the basis of intrinsic properties of social media items.

### BACKGROUND OF THE INVENTION

The early years following the mass acceptance of the World Wide Web were characterized primarily by a one way flow of information: a handful of resources, similar to traditional published material, were provided to a larger Web audience consuming the published material. Beginning in the early 21^{st} century this trend transformed into a two-way communication channel, where the previous consumers became individual publishers, publishing their own content aptly referred to as “user-generated content,” or “UGC”. Popular examples of UGC include blogs, web forums, social bookmarking sites, photo and video sharing communities and social networking platforms.

UGC opened the Web up to a greater wealth of information, allowing users to easily publish their thoughts, ideas and opinions, as well as allowing users to connect to other users across the globe. This increase in ability, however, opened the Web up to malicious intent, both intentional and unintentional. Users are able to post content ranging from mildly offensive content to content malicious enough to render aspects of websites virtually unusable, such as spam. This aspect of UGC eventually trickles down to the revenue of a site allowing UGC: as the less relevant the content of a site appears the fewer users frequent the site and the amount of revenue generated from the site directly or indirectly decreases.

The task of filtering offensive or malicious content becomes immediately more difficult in the new realm of UGC as it is difficult to monitor what content users are posting. Furthermore, given the volume of received content, manual inspection of content is impractical and automated inspection of content prone to error. Thus, there is a need in the current state of the art for systems and methods to filter UGC and identify the highest quality content efficiently and effectively. Additionally, there arises a need in the art that effectively exploits the inherent aspects of UGC (e.g., as user-user and user-item relationships) as well as the intrinsic aspects of UGC such as grammatical or typographical features, to provide an effective solution for filtering UGC.

### SUMMARY OF THE INVENTION

The present invention is directed towards systems, methods and computer program products for identifying high quality content in a social media environment. The method of the present invention comprises retrieving a content item, which may be a user-generated content item. The method then retrieves a plurality of quality features associated with said content item wherein said quality features may comprise intrinsic features.

In a first embodiment, quality features may further comprise a plurality of usage features comprising one of number of clicks associated with the content item or dwell time on the content item. In a second embodiment, quality features may further comprise relationship scores associated with said content item. In one embodiment, relationship scores may be stored within a graph wherein said graph comprises one of at least user to user edges and user to content item edges.

The method of the present invention then performs an analysis of said content item using a high quality content model. In a first embodiment, the method may further comprise weighting said plurality of quality features. In a second embodiment, the method may further comprise aggregating said quality features. The method then generates a quality score based on said analysis. In one embodiment, the high quality content model may comprise a manually trained model operative to automatically analyze said content item.

The system of the present invention comprises a plurality of client devices coupled to a network and a content store operative to store a plurality of content items. In one embodiment, a content item may comprise a user-generated content item. The system further comprises a feature store operative to store a plurality of quality features and a content server coupled to said network operative to retrieve a content item and further operative to retrieve a plurality of quality features associated with said content item wherein said quality features comprise intrinsic features. In a first embodiment, said quality features may further comprise a plurality of usage features wherein said usage features comprise one of number of clicks associated with said content item or dwell time on said content item. In a second embodiment, quality features further comprise relationship scores associated with said content item. In one embodiment, relationship scores may be stored within a graph wherein said graph comprises one of at least user to user edges and user to content item edges.

The system further comprises a feature analyzer operative to perform an analysis of said content item using a high quality content model and generate a quality score based on said analysis. In one embodiment, a feature analyzer may further be operative to weight said plurality of quality features. In a second embodiment, a feature analyzer may further be operative to aggregate said quality features. In one embodiment, the high quality content model may comprise a manually trained model operative to automatically analyze said content item.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for identifying high quality media in a social media context according to one embodiment of the present invention;

FIG. 2 presents a flow diagram for training a model for use in identifying high quality user generated content according to one aspect of the present invention;

FIG. 3 presents a flow diagram illustrating a method for identifying high quality media in a social media context according to one embodiment of the present invention; and

FIG. 4 provides a flow diagram illustrating a method for analyzing a social media graph according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

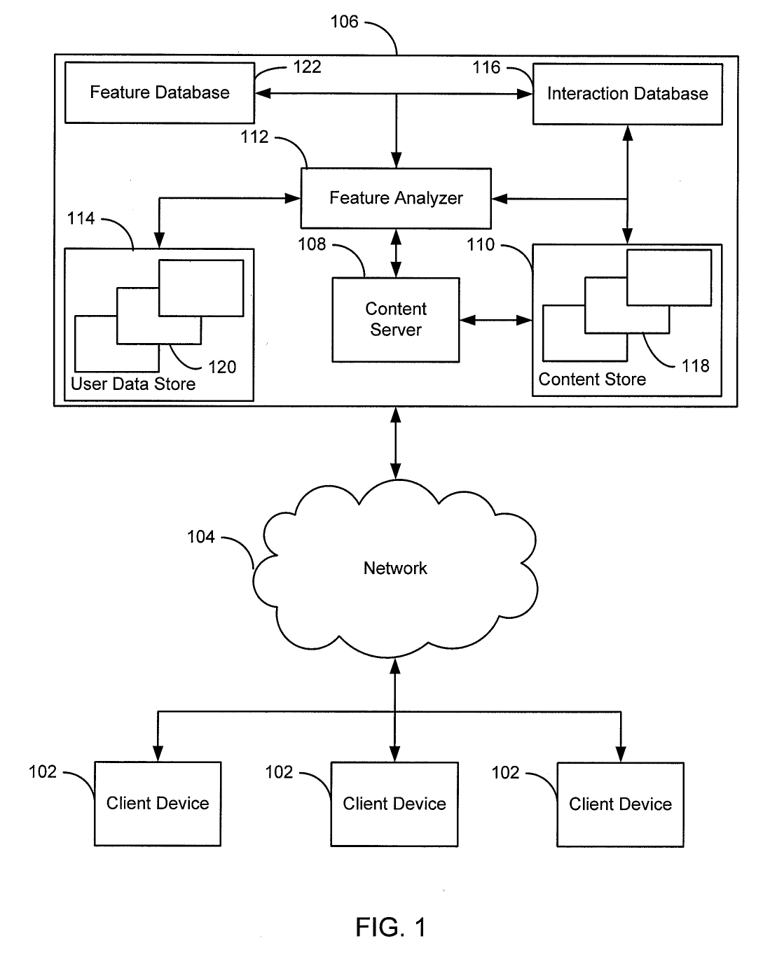

FIG. 1 presents a block diagram depicting a system for generating an aggregated feature set according to one embodiment of the present invention. According to the embodiment that FIG. 1 illustrates, at least a plurality of client devices 102 are communicatively coupled to a network 104, which may include a connection to one or more local or wide area networks, such as the Internet. A given client device 102 is in communication over the network 104 with a content provider 106. According to the present embodiment, a content provider 102 comprises a content server 108 operative to receive data requests from a given client device 102 and return appropriate or otherwise relevant data in response to the received data requests.

In addition to a content server 108, a content provider 106 further comprises a content store 110. In one embodiment, content store 110 may store content items 118 comprising user-generated content. For example, content store 110 may store a plurality of user-generated content items, such as questions and answers submitted by users. Content provider 106 may further comprise a user data store 114 operative to store data items 120 regarding users. In one embodiment, user data store 114 may comprise a relational database storing information regarding users and UGC items associated with a plurality of users.

Content server 108 is in further communication with feature analyzer 112. Feature analyzer 112 is operative to analyze user data store 114 and content store 110 to determine the quality of user generated content 118 based upon various quality metrics stored within feature database 122 and interaction database 116. As illustrated, feature database 122 may contain a plurality of features related to the quality of a UGC item 118. In one embodiment, features stored in feature database 122 may also comprise a plurality of quality metrics tuned prior to the examination of a given UGC item 118. For example, feature database 122 may indicate grammatical rules to utilize on a UGC item 118 as well as a quality threshold a UGC item 118 must surpass to be considered high quality content.

Additionally, feature analyzer 112 is operative to query interaction database 116. Interaction database 116 may store data relating to user interaction with a UGC item 118. For example, interaction database 116 may store data related to how many times a given UGC item 118 was clicked, how much time was spent viewing the UGC 118, or any other interaction metric known in the art. Feature analyzer 112 may query interaction database 116 for a given UGC item 118 and determine on the basis of the previous described metrics whether a given UGC item 118 is of high quality. For example, a UGC item 118 having a number of clicks above a given threshold may be determined to be of high quality. Alternatively, or in conjunction with the foregoing, an author of a UGC item 118 author may be extracted from the UGC item 118 and feature analyzer 112 may query user data store 114 to determine if the author of a given UGC item 118 is a “quality user.” A quality user may be interpreted as a user having a reputation of submitting high quality material.

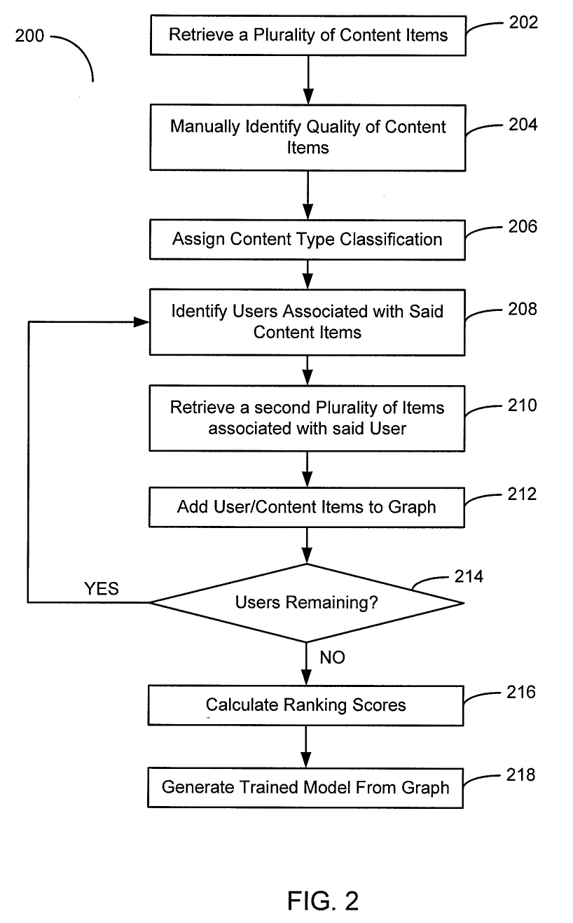

FIG. 2 illustrates a flow diagram for training a model for use in identifying high quality user generated content according to one aspect of the present invention. According to the illustrated embodiment, the method 200 retrieves a plurality of content items, step 202. In one embodiment, retrieving a plurality of content items may comprise selecting a random sample of content items from a larger corpus of homogenous content items. The method 200 then comprises manually identifying the quality of the retrieved content items, step 204. In the illustrated embodiment, manually identifying the quality of a content item may comprise manually viewing and rating a given content item. For example, a trained editor or team of editors may review the selected content item to determine whether it is, or it not, of high quality for a given content item domain. The method 200 then assigns a content type classification to the selected content item, step 206. In one embodiment, a content type classification may comprise a plurality of classification labels specific to the content item domain. For example, in a questions/answers portal, a content type classification may comprise question and answer pairs directed towards one of informational, advice, polls, etc. In alternative domains, various other classification labels may be used.

The method 200 then identifies users associated with the previously retrieved content items, step 208. In one embodiment, retrieving users associated with the previously retrieved content items may comprise accessing a database storing user to content items relationships and retrieve a plurality the plurality of users indexed by the content items. For example, in a questions/answers system, the content items may comprise a plurality of questions and answers which may be associated with a plurality of users. That is, a given question has an associated user, or questioner, and a given answer has an associated user, or answerer. The method 200 then retrieves a plurality of secondary content items associated with the selected users, step 210. In the illustrated embodiment, the content items retrieved in step 210 may be of the same type as those previously retrieved. Considering a questions/answers system, step 210 may retrieve a plurality of secondary questions and answers associated with a plurality of users identified in step 208. Retrieving a secondary set of items allows the method 200 to identify high quality content based on the assumption that users who submit high quality content at least once tend to submit higher quality content in general.

The method 200 then adds the user and content items to a graph as nodes, step 212. In the illustrated embodiment, a graph may be constructed in memory or on a persistent storage device such as magnetic disk. Adding users and content items to a graph may comprise defining a node for a given user or a given content item and associating an edge between users and content items, between users and users and between content items and content items. In one embodiment, and edge may comprise a plurality of weighting features including, but not limited to, scores given to content items and intrinsic or extrinsic rankings among both users and content items.

The method 200 determines if users remain from the plurality of selected users, step 214. If additional users remain, the method performed in steps 208, 210 and 212 repeats for a plurality of remaining users. If not, the method 200 calculates ranking scores from the generated graph, step 216. In one embodiment, the generated graph may contain a plurality of graphs, a given graph containing a plurality of unique metrics stored within the edges of the graph. In an alternative embodiment, the generated graph may contain a sole graph embodying a plurality of features within its edges. In the illustrated embodiment, calculating a ranking score may comprise aggregating and averaging one or more measure metrics from the generated graph. In alternative embodiment, more sophisticated calculations may be utilized to formulate a ranking score. For example, a non-linear complex function may be utilized in place of an aggregation scheme. In one embodiment, a ranking score may be generated by any function that maps the values of the underlying features (e.g., intrinsic, usage or relationship features) deterministically to a single, numerical quality score.

The method 200 finally generates a trained model from the graph, step 218. In the illustrated embodiment, a trained model comprises learned model operative to automatically determine the quality of an incoming content items based on the trained model. Alternatively, or in conjunction with the foregoing, a trained model may be operative to classify content items using a continuous quality scale. That is, a content item may be classified using degrees of quality, as opposed to a binary high/low quality rating. For example, a model may be operative to determine if a given content item is of low, medium or high quality by analyzing a “quality score” ranging over natural numbers. For example, a range of 0 to 25 may indicate low quality content, a range of 25 to 75 may indicate medium quality and a range of 75 to infinity may indicate high quality content, where a value of 100 may be an inherent maximum threshold.

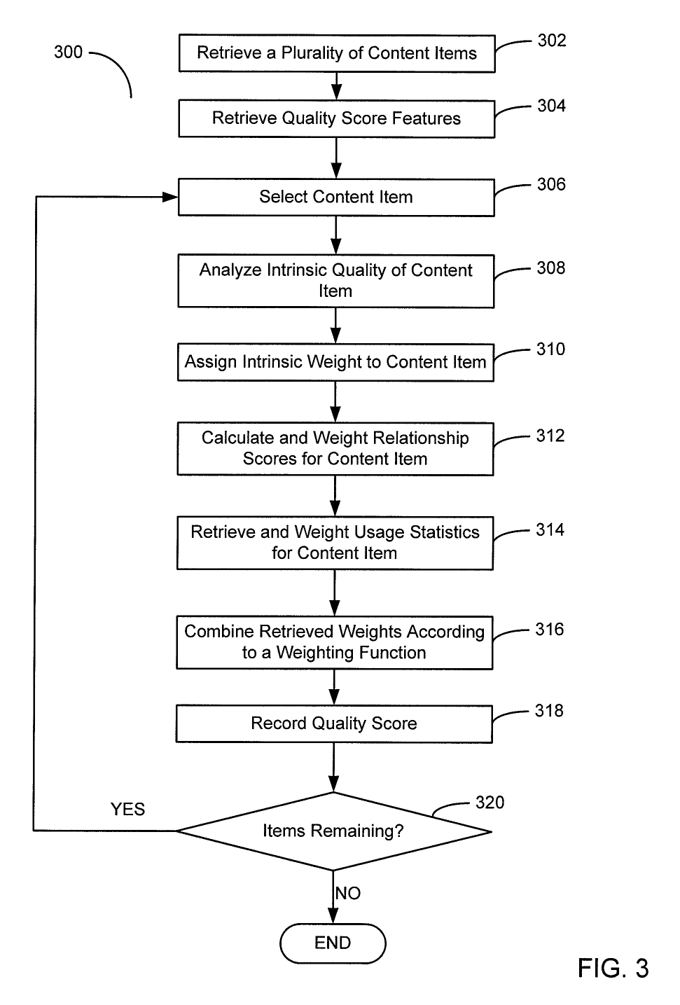

FIG. 3 illustrates a flow diagram illustrating a method for identifying high quality media in a social media context according to one embodiment of the present invention. As illustrated, the method 300 retrieves a plurality of content items, step 302. In one embodiment, method 300 may retrieve content items on the fly, that is, as they are submitted by users. Alternatively, or in conjunction with the foregoing, the method 300 may retrieve content items as a batch process, that is, processing a plurality of content items at the same time, either in parallel or in series.

The method 300 then retrieves a plurality of quality score features, step 304. In one embodiment, retrieving quality score feature may comprise retrieving a plurality of intrinsic, relationship or usage features or a combination thereof. In one embodiment, the retrieved quality score features may be determined dynamically based upon the domain. That is, a UGC item in domain A may have differing features as compared to a UGC item in domain B. For example, in a question and answer type social media site, a question in a children's domain may have differing features than that of a question in a philosophical domain: various grammatical aspects may be vastly different between the two domains.

The method 300 selects a given content item, step 306, and analyzes the intrinsic quality of the content item, step 308. Intrinsic quality of a content item may comprise a variety of grammatical features of the content item. For example, the punctuation, typographical errors and misspellings of a given content item may be an indication of the quality of a given item. In other embodiments, various other intrinsic qualities may be utilizes including, but not limited to, syntactic and semantic complexity and grammatical quality of the textual elements of the content item. In an alternative embodiment, analyzing the intrinsic quality of a content item may comprise calculating the term frequency for a given document. For example, a dictionary of available terms may be provided to the method 300 and the content of a given content may be analyzed to determine how many times a term within the dictionary occurs.

After identifying the intrinsic features of a given content item, the method 300 weights the intrinsic qualities according to a pre-determined weighting algorithm, step 310. In one embodiment, a weighting algorithm may determine a weight associated with one or more features as described above. Alternatively, or in conjunction with the foregoing, the weighting algorithm may adjust the weights of the intrinsic features based upon the domain of the selected content item. For example, a weighting algorithm may determine that grammatical consistency may have a lower weight for a first domain and a high weight for a second domain, depending on the domain topics.

The method 300 then calculates and weights relationship scores for a given content item, step 312. In one embodiment, calculating and weighting relationship scores may comprise generating a graph indicating the relationships between users and UGC items, as described further with respect to FIG. 3. Alternatively, or in conjunction with the foregoing, a generated graph may comprise relationships between users and other users or users and UGC items. In a first embodiment, weighting relationship scores may comprise using a link-analysis algorithm to determine where strong connections exist in the generated graph. For example, a user submitting a first content item may have submitted a plurality of other content items. Link analysis between the user and the plurality of other content items may determine that the other content items are of high quality, thus the first content item may be weighted as being of higher quality. In an alternative embodiment, other factors such as explicit or implicit user rating may be utilized to determine the relationship score of a selected content item.

The method 300 then retrieves and weights usage statistics for the selected content item, step 314. In one embodiment, usage statistics may comprise user interaction with the selected content item such as user clicks on the selected content time or dwell time (the time a user spends viewing the content item). In one embodiment, a weighting function for usage statistics may contemplate the nature of the content item being analyzed. For example, a content item directed towards a popular culture item (e.g., a content item related to celebrity gossip) may receive substantially more clicks or longer dwell time as compared to an unpopular or esoteric subject (e.g., a content item directed towards Tcl and C++ interoperability). In this scenario, the weighting algorithm may normalize the clicks based on historical data for the subject, or for the category of the content item. Although illustrated in series, steps 308-310, 312 and 314 may be performed in parallel to increase performance.

The method 300 then combines the retrieves weights according to a combination function, step 316, and records the quality score, step 318. In one embodiment, the combination function may comprise utilizing the model described with respect FIG. 2. The method 300 then determines if any content items remain, step 320, and repeats the method performed in steps 308, 310, 312 and 314 for the remaining items.

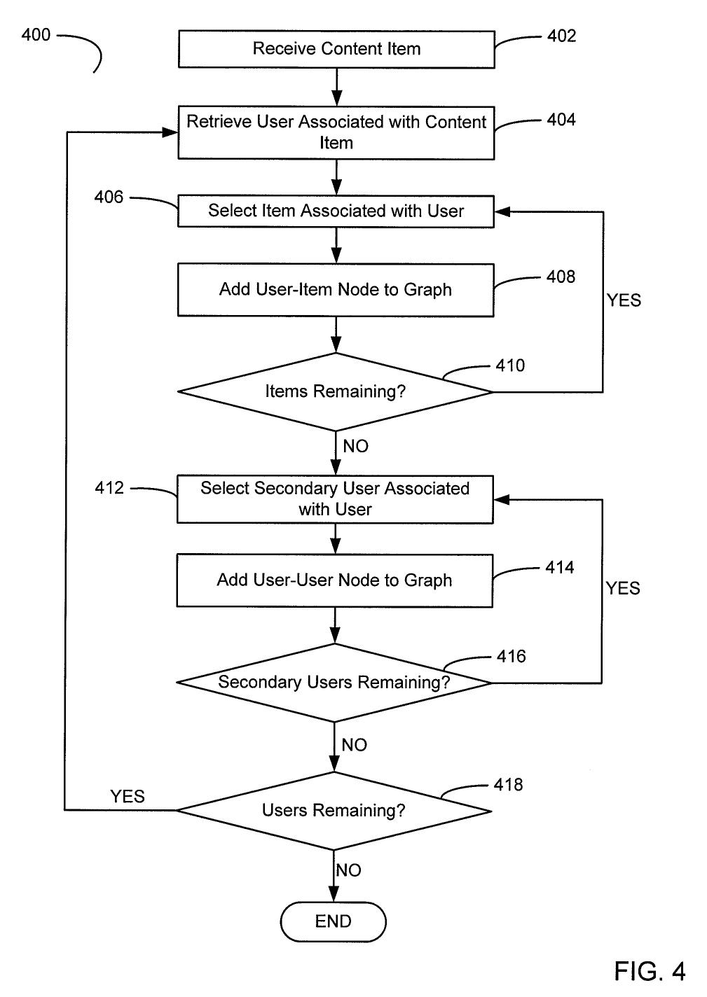

FIG. 4 illustrates a flow diagram illustrating a method for analyzing a social media graph according to one embodiment of the present invention. As illustrated, the method 400 receives a content item, step 402. In the illustrated embodiment, a content item may comprise a user-generated content item. For illustrative purposes, a content item may comprise a user-generated question with associated answers such as that provided by a question/answers portal.

The method 400 then retrieves a plurality of users associated with the content item, step 404. In one embodiment, the retrieved users may comprise retrieving a list of users associated with the selected content item. In the illustrative example, a plurality of users in a question/answer system may comprise the user providing the question and a plurality of users associated with one or more answers to the user question. The method 400 then selects an item associated with a selected user, step 408. In one embodiment, selecting an item associated with a user may comprise querying a database of content items and selecting an item associated with the user. In an alternative embodiment, items associated with a user may comprise user-generated content. For example, items associated with a user in a question/answer system may comprise questions asked by the user or answers provided by the user. In this example, an item may be associated with metadata such as a rating of the item. In one embodiment, edges of the resulting graph may provide an indication of the relationship between items, as is described in greater detail herein.

After selecting an item, the method 400 adds the user-item pair node to a relationship graph, step 408. In one embodiment, the resulting graph may be stored in memory and may be discarded after the graph is generated and utilized. In an alternative embodiment, the resulting graph may be stored and updated upon a change in the graph nodes. For example, the resulting graph may be updated in response to a user being associated with additional content items. As previously mentioned, upon adding a node to a graph, the result edge may be weighted with various quality features such as an explicit ranking of the added item or an implicit ranking of the item using features such as those described with respect to FIG. 2. The method 400 then checks to see if any items remain for a give user, step 410 and repeats the method performed by steps 406 and 408 for the remaining items.

The method described with respect to steps 406, 408 and 410 are directed generally to a method for generating a user-item graph comprise associations between users and items. However, the present invention as illustrated in FIG. 4 provides an additional relationship metric of user-user relationships. The method 400 first selects a secondary user associated with a first user, step 412. In one embodiment, selecting a secondary user may comprise performing a database query to determine which users are associated with the selected user. In one embodiment, users are not associated explicitly, but rather implicitly through a linking element, such as a content item. For example, in a question/answer system users may be linked via a content item comprising a question or answer. For example, user A may be connected to user B because user A answered a questioned posed by user B. In an alternative embodiment, users may be connected directly and these connections may be stored in a database or alternative storage structure.

After identifying a user-user pair, the method 400 adds the user-user node to the relationship graph, step 414. If any more user-user relationships exist, step 416, the method 400 repeats steps 412 and 414 for the remaining relationships. The method 400 then repeats for the remaining users associated with the selected content item, step 418. As previously mentioned, upon adding a node to a graph, the result edge may be weighted with various quality features such as an explicit ranking of the added item or an implicit ranking of the item using features such as those described with respect to FIG. 3.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for identifying high quality content in a social media environment, the method comprising:
retrieving a content item;
retrieving a plurality of quality features associated with said content item wherein said quality features comprise intrinsic, usage and relationship features;
performing an analysis of said content item using a high quality content model; and
generating a quality score based on said analysis.

2. The method of claim 1 wherein said content item comprises a user-generated content item.

3. The method of claim 1 wherein said usage features comprise one of number of clicks associated with said content item or dwell time on said content item.

4. The method of claim 1 wherein said quality features comprise relationship scores that are stored within a graph.

5. The method of claim 4 wherein said graph comprises one of at least user to user edges and user to content item edges.

6. The method of claim 1 further comprising weighting said plurality of quality features.

7. The method of claim 1 further comprising aggregating said quality features.

8. The method of claim 1 wherein said high quality content model comprises a manually trained model operative to automatically analyze said content item.

9. A system for identifying high quality content in a social media environment, the system comprising:
a plurality of client devices coupled to a network;
a content store operative to store a plurality of content items;
a feature store operative to store a plurality of quality features;
a content server coupled to said network operative to retrieve a content item and further operative to retrieve a plurality of quality features associated with said content item wherein said quality features comprise intrinsic, usage and relationship features; and
a feature analyzer operative to perform an analysis of said content item using a high quality content model and generate a quality score based on said analysis.

10. The system of claim 9 wherein said content item comprises a user-generated content item.

11. The system of claim 9 wherein said usage features comprise one of number of clicks associated with said content item or dwell time on said content item.

12. The system of claim 9 wherein said quality feature comprise relationship scores that are stored within a graph.

13. The system of claim 12 wherein said graph comprises one of at least user to user edges and user to content item edges.

14. The system of claim 9 wherein said feature analyzer is further operative to weight said plurality of quality features.

15. The system of claim 9 wherein said feature analyzer is further operative to aggregate said quality features.

16. The system of claim 11 wherein said high quality content model comprises a manually trained model operative to automatically analyze said content item.
